(19) United States
(12) Patent Application Publication
(10) Pub. No.: US 2023/0229830 A1
(43) Pub. Date: Jul. 20, 2023

(54) METHOD FOR COUPLING HYDRAULIC FRACTURE NETWORK EXTENSION AND PRODUCTION PERFORMANCE OF HORIZONTAL WELL IN UNCONVENTIONAL OIL AND GAS RESERVOIR

(71) Applicant: Southwest Petroleum University, (US)

(72) Inventors: Yulong ZHAO, Chengdu (CN); Liehui ZHANG, Chengdu (CN); Ruihan ZHANG, Chengdu (CN); Bin ZENG, Chengdu (CN); Huiying TANG, Chengdu (CN); Jun PAN, Chengdu (CN); Xiao HE, Chengdu (CN); Zhidong YANG, Chengdu (CN)

(73) Assignee: Southwest Petroleum University, Chengdu (CN)

(21) Appl. No.: 17/787,597

(22) PCT Filed: Mar. 31, 2022
(86) PCT No.: PCT/CN2022/084277

§ 371 Date: Jun. 21, 2022

(30) Foreign Application Priority Data
Apr. 12, 2021 (CN) 202110388522.3

(51) Int. Cl. G06F 30/23; E21B 43/30; E21B 43/267

(52) U.S. Cl. CPC G06F 30/23; E21B 43/305; E21B 43/267; E21B 2200/20; G06F 2111/10

(57) ABSTRACT

A method for coupling hydraulic fracture network extension and production performance of a horizontal well in an unconventional oil and gas reservoir includes: establishing a complex hydraulic fracture network model of a fractured horizontal well in an unconventional oil and gas reservoir based on a fracture extension theory; constructing three-dimensional three-phase mathematical models of seepage for the fractured horizontal well based on an embedded discrete fracture model; and constructing a fully implicit numerical calculation model by a finite difference method through three-dimensional orthogonal grids, and solving iteratively, thereby accurately predicting a production performance characteristic of the fractured horizontal well in the unconventional oil and gas reservoir. The method combines a fracture extension model with a production performance prediction model to realize the coupled simulation and prediction of the hydraulic fracture network extension and production performance of the horizontal well in the unconventional oil and gas reservoir.

### TECHNICAL FIELD

The present disclosure relates to the technical field of unconventional oil and gas reservoir exploitation, and in particular to a method for coupling hydraulic fracture network extension and production performance of a horizontal well in an unconventional oil and gas reservoir.

### BACKGROUND

In China, the huge unconventional oil and gas reservoir resources have become the main areas of the country for increasing reserves and production at present and in the future. Compared with conventional oil and gas reservoirs, unconventional oil and gas reservoirs have more complex geological conditions with natural fractures, featuring low porosity and low permeability, and resulting in extremely low oil and gas production. Field practice shows that the techniques of horizontal wells with long sections and stimulated reservoir volume (SRV) fracturing are the main means for unconventional oil and gas reservoirs to obtain industrial productivity. The fluid with a higher pressure than the fracturing pressure is injected into the formation to create hydraulic fractures and open natural fractures, and a proppant is pumped to provide effective support for the fractures, so as to build an effective flow channel from the reservoir to the wellbore.

Therefore, the key to the accurate prediction of the production performance of the fractured horizontal well in the unconventional oil and gas reservoir lies in the accurate characterization of the hydraulic fracture network extension shape and the accurate prediction of the post-fracture production performance of the horizontal well with coupled complex flow laws. However, the existing hydraulic fracture network extension and gas well production performance simulation are independent of each other, making it hard to capture the mutual dynamic response of mechanics and flow, thereby resulting in the lack of an effective coupled simulation technique.

### SUMMARY

In view of this, an objective of the present disclosure is to provide a method for a coupled simulation of hydraulic fracture network extension and production performance of a horizontal well in an unconventional oil and gas reservoir. The method of the present disclosure includes: establishing a complex hydraulic fracture network model of a fractured horizontal well in an unconventional oil and gas reservoir based on a fracture extension theory; constructing three-dimensional three-phase mathematical models of seepage for the fractured horizontal well based on an embedded discrete fracture model; and constructing a fully implicit numerical calculation model by a finite difference method through three-dimensional orthogonal grids, and solving iteratively, thereby accurately predicting a production performance characteristic of the fractured horizontal well in the unconventional oil and gas reservoir. The method of the present disclosure specifically includes the following steps:

S1: constructing, based on a displacement discontinuity method, a displacement discontinuity and stress relationship model of a fracture element and a fracture failure type criterion;

S2: constructing a numerical model for hydraulic fracture network extension of a horizontal well by comprehensively considering a reservoir's natural fracture distribution characteristic, and hydraulic fracture flow, extension and deformation, and acquiring, through iterative simultaneous solution, an extension shape and a spatial distribution characteristic of a hydraulic fracture network;

S3: generating a geological body of the horizontal well based on the extension shape and spatial distribution characteristic of the hydraulic fracture network, and performing spatial grid discretization by three-dimensional orthogonal grids;

S4: constructing, based on an embedded discrete fracture model, three-dimensional three-phase mathematical models of seepage for the horizontal well and a fully implicit numerical model based on a finite difference algorithm; and

S5: iteratively solving the constructed fully implicit numerical model, and predicting a post-fracture production performance characteristic of the horizontal well.

The present disclosure has the following beneficial effects:

1. By comprehensively considering the distribution characteristic of the natural fracture in the unconventional oil and gas reservoir, as well as the effects of proppant settlement and filtration of different components of the fracturing fluid during hydraulic fracturing, the present disclosure constructs a hydraulic fracture network extension model for the horizontal well, and realizes accurate prediction of the complex hydraulic fracture network extension shape.

2. Based on the extension characteristics of the hydraulic fracture, the present disclosure constructs the three-dimensional three-phase fully implicit numerical model of the fractured horizontal well by combining the finite difference method and three-dimensional orthogonal grids. The present disclosure realizes the coupled simulation of the hydraulic fracture network extension and production performance of the horizontal well in the unconventional oil and gas reservoir, and overcomes the shortcomings of the traditional independent hydraulic fracture network extension model and production performance prediction model.

### BRIEF DESCRIPTION OF THE DRAWINGS

FIG. 1 is a flowchart of a method for coupling hydraulic fracture network extension and production performance of a horizontal well in an unconventional oil and gas reservoir;

FIG. 2 is a schematic view of a hydraulic fracture extension shape of the horizontal well considering a natural fracture distribution;

FIG. 3 is a schematic view of three-dimensional grid partition of the horizontal well and a fracture network;

FIG. 4 shows a production pressure distribution of the fractured horizontal well;

FIG. 5 shows a forecast curve of daily oil production and cumulative oil production;

FIG. 6 shows a forecast curve of daily water production and cumulative water production; and

FIG. 7 shows a forecast curve of daily gas production and cumulative gas production.

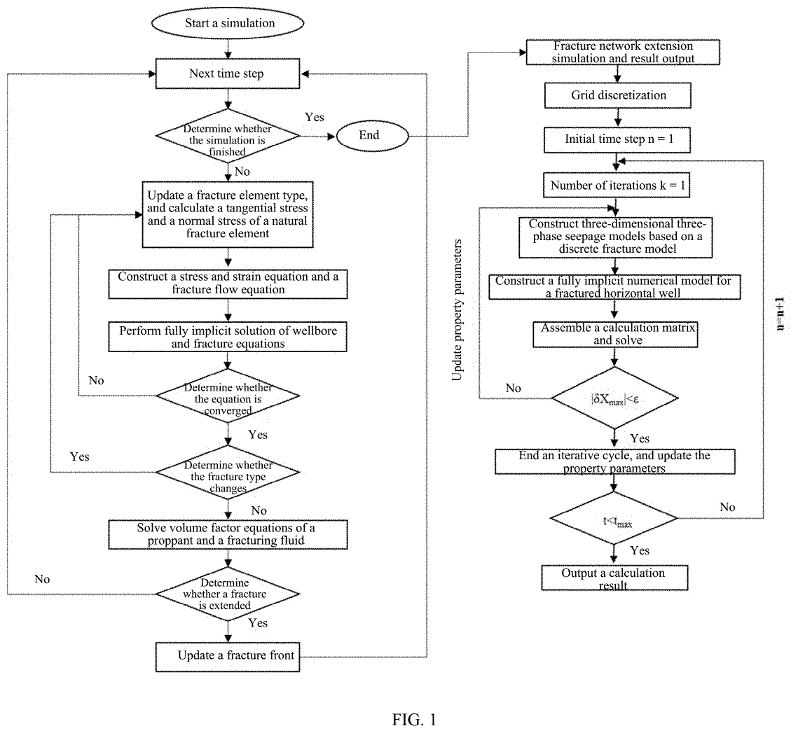

### DETAILED DESCRIPTION OF THE EMBODIMENTS

To describe the technical features, objectives and beneficial effects of the present disclosure more clearly, the technical solutions of the present disclosure are described in detail below, but it should not be construed that the protection scope of the present disclosure is limited thereto. All other embodiments obtained by those of ordinary skill in the art based on the embodiments of the present disclosure without creative efforts should fall within the protection scope of the present disclosure.

The present disclosure is described in further detail below with reference to the drawings and embodiments.

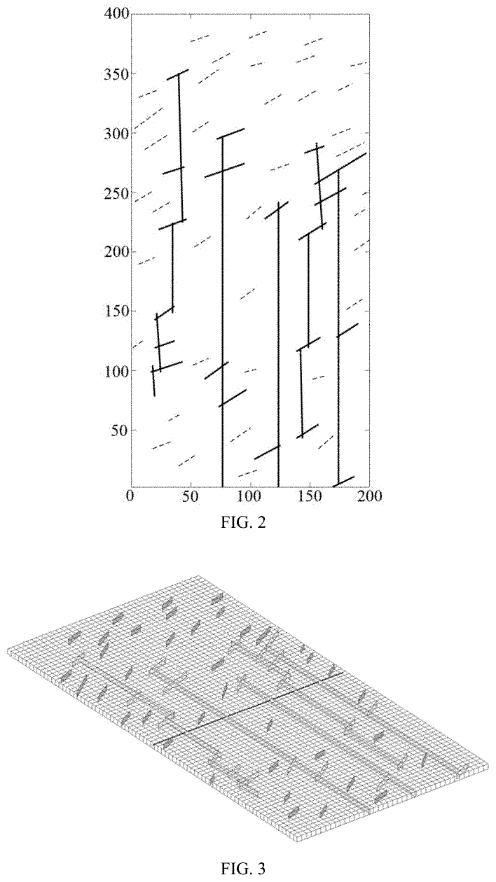

(1) First, geomechanical parameters, natural fracture parameters and engineering parameters of the reservoir are input, and simulation is performed based on a fracture failure type criterion, to obtain the shape and spatial distribution characteristics of the hydraulic fracture network, as shown in FIG. 2.

The specific parameters used in this embodiment are shown in Table 1.

TABLE 1
Case calculation parameters

| Parameter | Value | Unit |
|---|---|---|
| Minimum horizontal principal stress | 40 | MPa |
| Maximum horizontal principal stress | 40.5 | MPa |
| Young's modulus | 30 | GPa |
| Poisson's ratio | 0.25 | — |
| Fluid viscosity | 9 | cp |
| Proppant diameter | 0.00015 | m |
| Proppant density | 2800 | kg/m³ |
| Fracture spacing | 30 | m |
| Type I cracking toughness of matrix rock | 2 | MPa · m^{1/2} |
| Type II cracking toughness of matrix rock | 4 | MPa · m^{1/2} |
| Initial aperture of natural fracture | 0.2 | 1e⁻⁵ m |
| Closure aperture of natural fracture | 1 | 1e⁻⁵ m |
| Compressibility of natural fracture | 0.05 | MPa⁻¹ |
| Friction angle of natural fracture | 20 | ° |

(2) Spatial grid partition is performed on the extension shape of the generated hydraulic fracture network by using three-dimensional orthogonal grids. The total calculation area has a volume is 400×200×20 m³, and the length of the horizontal well section in the calculation area is 200 m. A five-section multi-stage hydraulic fracture is created through hydraulic fracturing, as shown in FIG. 3.

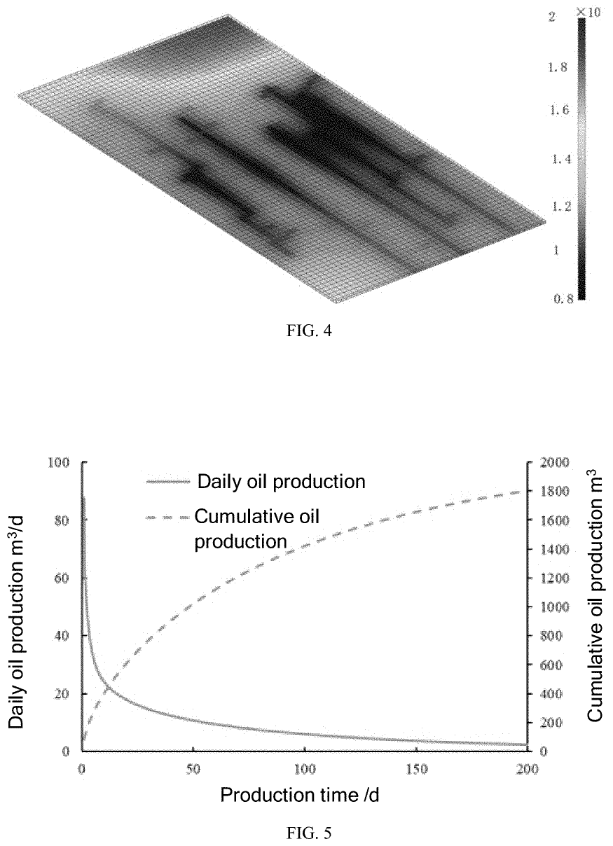

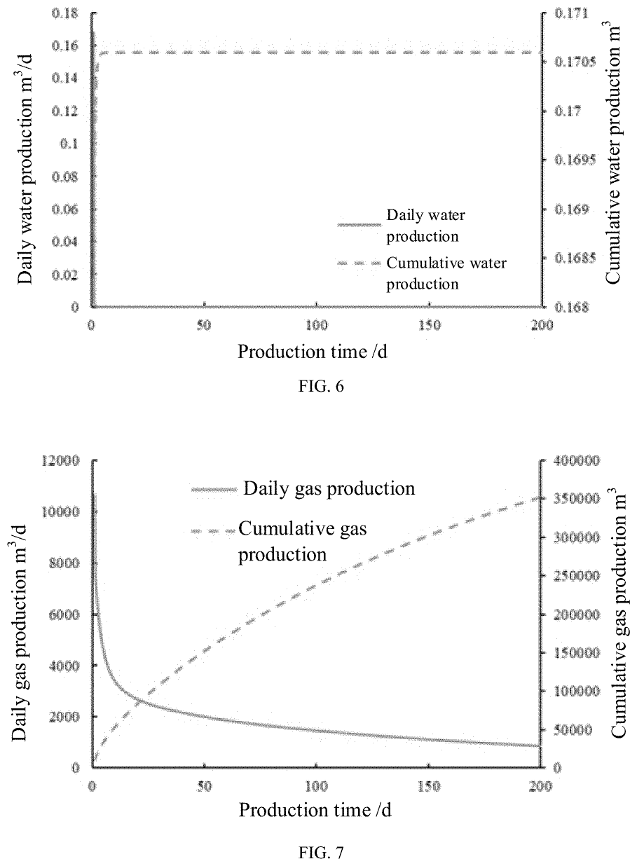

(3) Based on the reservoir grid partition results are combined with the three-dimensional three-phase fully implicit numerical model of fractured horizontal well. The basic parameters of the model (Table 2), the pressure-volume-temperature (PVT) parameters (Table 3) of crude oil and natural gas, matrix permeability data (Table 4 and Table 5), and matrix capillary force data (Table 6) are brought to obtain the production performance data of the simulated well, and the post-fracture production performance characteristics of the horizontal well are predicted, as shown in FIGS. 4 to 7.

TABLE 2
Basic parameters of model

| Parameter | Value | Parameter | Value |
|---|---|---|---|
| Matrix permeability, | 0.001 | Formation water | 4 × 10⁻⁴ |
| D | | compressibility, | |
| | | MPa⁻¹ | |
| Rock compressibility, | 10⁻⁴ | Formation water | 0.0009 |
| MPa⁻¹ | | viscosity, Pa · s | |
| Initial porosity, | 0.1 | Initial water saturation, | 0.3 |
| dimensionless | | dimensionless | |
| Hydraulic fracture | 25 | Initial oil saturation, | 0.7 |
| permeability, D | | dimensionless | |
| Initial oil-phase | 20 | Flowing bottom-hole | 8 |
| pressure, MPa | | pressure, MPa | |
| Initial volume factor of | 1.01 | Aperture of hydraulic | 0.005 |
| formation water, | | fracture, m | |
| dimensionless | | | |
| Initial density of | 1010 | Aperture of natural | 0.003 |
| formation water, | | fracture, m | |
| kg/m³ | | | |

TABLE 3
PVT parameters of crude oil and natural gas

| | Crude oil | | | | | | |
|---|---|---|---|---|---|---|---|
| | | | | Solution gas-oil | Natural gas | | |
| Pressure | Density | Viscosity | Volume factor | ratio | Density | Viscosity | Volume factor |
| (kPa) | (kg/m³) | (cP) | Dimensionless | Dimensionless | (kg/m³) | (cP) | Dimensionless |
| 3000 | 660.13 | 1.17 | 1.1806 | 45.93 | 25.9351 | 0.012654 | 0.035502 |
| 4500 | 652.26 | 0.97 | 1.2104 | 57.63 | 38.6406 | 0.01315 | 0.023019 |
| 6000 | 644.92 | 0.85 | 1.2397 | 69.43 | 51.8383 | 0.013675 | 0.016821 |
| 7500 | 637.83 | 0.76 | 1.2698 | 81.65 | 65.6071 | 0.014254 | 0.013138 |
| 9000 | 630.87 | 0.69 | 1.3010 | 94.44 | 79.956 | 0.014907 | 0.010714 |
| 10500 | 623.96 | 0.64 | 1.3338 | 107.92 | 94.848 | 0.015649 | 0.009012 |
| 12000 | 617.07 | 0.58 | 1.3734 | 122.18 | 110.212 | 0.016493 | 0.007762 |
| 13500 | 617.83 | 0.58 | 1.3697 | 122.18 | — | — | — |
| 15000 | 619.82 | 0.60 | 1.3653 | 122.18 | — | — | — |
| 16500 | 621.74 | 0.61 | 1.3611 | 122.18 | — | — | — |
| 18000 | 623.58 | 0.63 | 1.3571 | 122.18 | — | — | — |
| 19500 | 625.34 | 0.64 | 1.3533 | 122.18 | — | — | — |
| 21000 | 627.04 | 0.66 | 1.3496 | 122.18 | — | — | — |

TABLE 4
Matrix oil-water permeability

| s_{w} | k_{rw} | kᵣₒ |
|---|---|---|
| 0.21 | 0.0000 | 1.0000 |
| 0.24 | 0.0074 | 0.8565 |
| 0.27 | 0.0209 | 0.7291 |
| 0.30 | 0.0385 | 0.6164 |
| 0.33 | 0.0592 | 0.5174 |
| 0.36 | 0.0827 | 0.4307 |
| 0.39 | 0.1088 | 0.3555 |
| 0.42 | 0.1371 | 0.2905 |
| 0.45 | 0.1674 | 0.2349 |
| 0.48 | 0.1998 | 0.1877 |
| 0.51 | 0.2340 | 0.1480 |
| 0.54 | 0.2700 | 0.1150 |
| 0.57 | 0.3076 | 0.0878 |
| 0.60 | 0.3469 | 0.0657 |
| 0.63 | 0.3876 | 0.0481 |
| 0.66 | 0.4299 | 0.0343 |
| 0.69 | 0.4736 | 0.0237 |
| 0.72 | 0.5187 | 0.0158 |
| 0.75 | 0.5651 | 0.0100 |
| 0.78 | 0.6129 | 0.0060 |
| 0.81 | 0.6619 | 0.0033 |
| 0.84 | 0.7121 | 0.0017 |
| 0.87 | 0.7636 | 0.0007 |
| 0.90 | 0.8163 | 0.0003 |

TABLE 5
Matrix oil-gas permeability

| s_{g} | k_{rg} | kᵣₒ |
|---|---|---|
| 0.04 | 0 | 1 |
| 0.08 | 0.01103 | 0.70778 |
| 0.12 | 0.02912 | 0.55844 |
| 0.16 | 0.05138 | 0.4454 |
| 0.20 | 0.07687 | 0.35562 |
| 0.24 | 0.10506 | 0.28302 |
| 0.28 | 0.13561 | 0.22392 |
| 0.32 | 0.16827 | 0.17574 |
| 0.36 | 0.20286 | 0.13656 |
| 0.40 | 0.23923 | 0.10485 |
| 0.44 | 0.27725 | 0.07938 |
| 0.48 | 0.31683 | 0.05912 |
| 0.52 | 0.35788 | 0.04319 |
| 0.56 | 0.40031 | 0.03084 |
| 0.60 | 0.44408 | 0.02143 |
| 0.64 | 0.48911 | 0.01442 |
| 0.68 | 0.53536 | 0.00933 |
| 0.72 | 0.58279 | 0.00574 |
| 0.76 | 0.63134 | 0.00332 |
| 0.79 | 0.67989 | 0.0009 |

TABLE 6
Matrix oil-water and gas-oil capillary force

| s_{w}, | p_{cow}, | 1-s_{g}, | p_{cgo}, |
|---|---|---|---|
| dimensionless | kPa | dimensionless | kPa |
| 0.2 | 8000 | 0.21 | 4760 |
| 0.25 | 4300 | 0.26 | 2940 |
| 0.3 | 3000 | 0.31 | 2220 |
| 0.4 | 1780 | 0.41 | 1490 |
| 0.5 | 1210 | 0.51 | 1040 |
| 0.6 | 790 | 0.66 | 510 |
| 0.7 | 430 | 0.76 | 270 |
| 0.8 | 100 | 0.96 | 0 |
| 0.9 | 0 | | |

The present disclosure is described above with reference to the preferred embodiments, but those skilled in the art should understand that these embodiments are only intended to describe the present disclosure, rather than to limit the scope of the present disclosure. Further improvements of the present disclosure made without departing from the principle of the present disclosure should also be deemed as falling within the protection scope of the present disclosure.

What is claimed is:

1. A method for coupling hydraulic fracture network extension and production performance of a horizontal well in an unconventional oil and gas reservoir, comprising the following steps:
S1: constructing, based on a displacement discontinuity method, a displacement discontinuity and stress relationship model of a fracture element and a fracture failure type criterion;
S2: constructing a numerical model for hydraulic fracture network extension of the horizontal well by comprehensively considering a reservoir's natural fracture distribution characteristic and hydraulic fracture flow, extension and deformation, and acquiring, through iterative simultaneous solution, an extension shape and a spatial distribution characteristic of a hydraulic fracture network;
S3: generating a geological body of a fractured horizontal well based on the extension shape and the spatial distribution characteristic of the hydraulic fracture network, and performing spatial grid discretization by three-dimensional orthogonal grids;
S4: constructing, based on an embedded discrete fracture model, three-dimensional three-phase mathematical models of seepage for the fractured horizontal well and a fully implicit numerical model based on a finite difference algorithm; and
S5: iteratively solving the fully implicit numerical model, and predicting a post-fracture production performance characteristic of the horizontal well.

2. The method for coupling hydraulic fracture network extension and production performance of the horizontal well in the unconventional oil and gas reservoir according to claim 1, wherein step S1 comprises:
S11: assuming a vertical height of a pseudo-three-dimensional fracture with a series of line segment elements horizontally to be a reservoir thickness, wherein when the fracture is subjected to an external load, relative sliding occurs between upper and lower surfaces of the fracture element; and defining variables to be calculated in each fracture element, namely a normal displacement Dₙ and a tangential displacement Dₛ, as displacement discontinuities:
Dₛ=uₓ(x,0⁻)−uₓ(x,0⁺) (1)=
Dₙ=u_{y}(x,0⁻)−u_{y}(x,0⁺) (2)
wherein, uₓ(x,y), u_{y}(x,y) denote surface displacements of the fracture element at a point (x,y) along an x-axis and a y-axis, respectively, m; and 0⁺ and 0⁻ denote upper and lower wall surfaces of the fracture element along the y-axis, respectively;
expressing a stress, a strain and a displacement of the fracture element at any point in space by the displacement discontinuities:
uₓ=[2(1−v)f′_{y}−yf′ₓₓ]+[−(1−2v)g′ₓ−yg′_{xy}] (3)
u_{y}=[(1−2v)f′ₓ−yf′_{xy}]+[2(1−v)g′_{y}−yg′_{yy}] (4)
σₓₓ=2G[2f′_{xy}+yf′_{xyy}]+2G[g′_{yy}+yg′_{yyy}] (5)
σ_{yy}=2G[−yf′_{xyy}]+2G[g′_{yy}−yg′_{yyy}] (6)
τ_{xy}=2G[2f′_{yy}+yf′_{yyy}]+2G[−yg′_{xyy}] (7)
wherein, σ(·) denotes a stress tensor of the fracture element, with a subscript xx denoting a stress perpendicular to a yz plane, and a subscript yy denoting a stress perpendicular to an xz plane; T denotes a shear stress tensor of the fracture element; G denotes a shear modulus of an elastic medium; v denotes a Poisson's ratio; y denotes a y-axis coordinate at any point; f′(·) and g′(·) denote derivations of integral functions f and g, respectively, with a subscript denoting an independent variable, for example:
$${f}_{xyy}^{′} = \frac{{\partial }^{3} f}{\partial x {\partial }^{2} y} ;$$
f and g respectively denote Green's function integrals along the fracture element, which are given by:
$$f ( x , y ) = \frac{- 1}{4 π ( 1 - v )} {\int }_{- a}^{a} {D}_{s} ( ξ ) ln [ \sqrt{{( x - ξ )}^{2} + {y}^{2}} ] d ξ \qquad ( 8 )$$
$$g ( x , y ) = \frac{- 1}{4 π ( 1 - v )} {\int }_{- a}^{a} {D}_{n} ( ξ ) ln [ \sqrt{{( x - ξ )}^{2} + {y}^{2}} ] d ξ \qquad ( 9 )$$
wherein, x and y denote point coordinates of the fracture element; and a denotes a displacement;
the stress and strain of any fracture element under the external load are calculated according to equations (3) to (9);
regarding fracture extension, a fracture boundary condition is provided by a fluid in the fracture, and a normal stress is equal to a fluid pressure; since the fluid does not have shear resistance, a shear stress at a fracture boundary is 0; and therefore, the fracture boundary condition is:
σₙ=−p (10)
τ=0 (11)
wherein, p denotes the fluid pressure in the fracture, MPa; σₙ denotes the normal stress at the fracture boundary; and r denotes the shear stress at the fracture boundary;
regarding the line segment elements of the fracture, all the stress of any line segment element is a sum of an induced stress acting on the fracture element, so matrix equations of the line segment elements of the fracture are:
$$[ \begin{matrix}{a}_{s 11} & {a}_{s 12} & … & {a}_{s 1 N} \\ … & … & {a}_{sij} & … \\ {a}_{sN 1} & {a}_{sN 2} & … & {a}_{sNN} \\ {a}_{n 11} & {a}_{n 12} & … & {a}_{n 1 N} \\ … & … & {a}_{nij} & … \\ {a}_{nN 1} & {a}_{nN 2} & … & {a}_{nNN}\end{matrix} ] [ \begin{matrix}{D}_{1 s} \\ ⋮ \\ {D}_{N s} \\ {D}_{1 n} \\ ⋮ \\ {D}_{Nn}\end{matrix} ] = [ \begin{matrix}{τ}_{1} \\ ⋮ \\ {τ}_{N} \\ {p}_{1} \\ ⋮ \\ {p}_{N}\end{matrix} ] \qquad ( 12 )$$
wherein, D_{Ns} denotes a tangential displacement of an N-th fracture element; D_{Nn} denotes a normal displacement of the N-th fracture element; N denotes a number of line segment elements of the fracture; aₛᵢⱼ denotes a tangential displacement component caused by a tangential displacement of a j-th element along the y-axis on an i-th element along the x-axis; aₙᵢⱼ denotes a normal displacement component caused by a normal displacement of the j-th element along the y-axis on the i-th element along the x-axis; τ_{N} denotes a shear stress at the N-th fracture element; and p_{N} denotes a fluid pressure at the N-th fracture element;
aₛᵢⱼ and aₙᵢⱼ are expressed as follows:
$${a}_{sij} = \frac{G}{2 π ( 1 - v )} [ 2 {n}_{j} {l}_{j} ( {n}_{j}^{2} + {l}_{j}^{2} ) {F}_{1} + ( {n}_{j}^{2} - {l}_{j}^{2} ) {F}_{2} + 2 {n}_{j} {l}_{l} {ζ}_{ij} ( {n}_{j} {F}_{3} - {l}_{j} {F}_{4} ) + {ζ}_{ij} ( {n}_{j}^{2} - {l}_{j}^{2} ) ( {l}_{j} {F}_{3} + {n}_{j} {F}_{4} ) ] \qquad ( 13 )$$
$${a}_{nij} = \frac{G}{2 π ( 1 - v )} [ ( 2 {n}_{j} {l}_{j}^{3} + 2 {n}_{j}^{3} {l}_{j} ) {F}_{1} + ( {n}_{j}^{2} - {l}_{j}^{2} ) ( {l}_{j}^{2} + {n}_{j}^{2} ) {F}_{2} + {ζ}_{ij} ( {l}_{j}^{2} - {n}_{j}^{2} ) ( {l}_{j} {F}_{3} + {n}_{j} {F}_{4} ) + 2 {n}_{j} {l}_{j} {ζ}_{ij} ( {l}_{j} {F}_{4} - {n}_{j} {F}_{3} ) ] \qquad ( 14 )$$
wherein
$${F}_{1} = \frac{( {n}_{j}^{2} - {l}_{j}^{2} ) {ζ}_{ij} - 2 {n}_{j} {l}_{j} ( {ξ}_{ij} + {M}_{j} )}{{( {ξ}_{ij} + {a}_{j} )}^{2} + {ζ}_{ij}^{2}} - \frac{{( {n}_{j}^{2} - {l}_{j}^{2} )}_{ij} - 2 {n}_{j} {l}_{j} ( {ξ}_{ij} - {M}_{j} )}{{( {ξ}_{ij} - {M}_{j} )}^{2} + {ζ}_{ij}^{2}} \qquad ( 15 )$$
$${F}_{2} = - \frac{2 {n}_{j} {l}_{j} {ζ}_{ij} + ( {n}_{j}^{2} - {l}_{j}^{2} ) ( {ξ}_{ij} + {M}_{j} )}{{( {ξ}_{ij} + {M}_{j} )}^{2} + {ζ}_{ij}^{2}} + \frac{2 {n}_{j} {l}_{j} {ζ}_{ij} + ( {n}_{j}^{2} - {l}_{j}^{2} ) ( {ξ}_{ij} - {M}_{j} )}{{( {ξ}_{ij} - {M}_{j} )}^{2} + {ζ}_{ij}^{2}} \qquad ( 16 )$$
$${F}_{3} = \frac{{n}_{j} ( {n}_{j}^{2} - 3 {l}_{j}^{2} ) [ {( {ξ}_{ij} + {M}_{j} )}^{2} - {ζ}_{ij}^{2} ] + 2 {l}_{j} ( 3 {n}_{j}^{2} - {l}_{j}^{2} ) ( {ξ}_{ij} + {M}_{j} ) {ζ}_{ij}}{{[ {( ξ + {M}_{j} )}^{2} + {ζ}_{ij}^{2} ]}^{2}} - \frac{{n}_{j} [ ( {n}_{j}^{2} - 3 {{l}_{j}^{2} ( {ξ}_{ij} - {M}_{j} )}^{2} - {ζ}_{ij}^{2} ] + 2 {l}_{j} ( 3 {n}_{j}^{2} - {l}_{j}^{2} ) ( {ξ}_{ij} - {M}_{j} ) {ζ}_{ij}}{{[ {( ξ - {M}_{j} )}^{2} + {ζ}_{ij}^{2} ]}^{2}} \qquad ( 17 )$$
$${F}_{4} = \frac{2 {n}_{j} ( {n}_{j}^{2} - 3 {l}_{j}^{2} ) ( {ξ}_{ij} + {M}_{j} ) {ζ}_{ij} - {l}_{j} ( 3 {n}_{j}^{2} - {l}_{j}^{2} ) [ {( {ξ}_{ij} + {M}_{j} )}^{2} - {ζ}_{ij}^{2} ]}{{[ {( ξ + {M}_{j} )}^{2} + {ζ}_{ij}^{2} ]}^{2}} - \frac{2 {n}_{j} ( {n}_{j}^{2} - 3 {l}_{j}^{2} ) ( {ξ}_{ij} - {M}_{j} ) {ζ}_{ij} - {l}_{j} ( 3 {n}_{j}^{2} - {l}_{j}^{2} ) [ {( {ξ}_{ij} - {M}_{j} )}^{2} - {ζ}_{ij}^{2} ]}{{[ {( ξ - {M}_{j} )}^{2} + {ζ}_{ij}^{2} ]}^{2}} \qquad ( 18 )$$
a conversion formula between global coordinates and local coordinates is:
ξ=n(x−c)−l(y−d) (19)
ζ=l(x−c)+n(y−d) (20)
wherein, ξᵢⱼ and ζᵢⱼ denote local coordinate values; l and n denote cosine values of angles between a ζ-axis and the x-axis and the y-axis, with a subscript j denoting a cosine value of an angle of the j-th fracture element; c and d denote distances from an origin of a ξ-ζ local coordinate system to the x-axis and the y-axis of a global coordinate system, respectively; and Mⱼ denotes a half-length of the j-th fracture element;
solving equation (12) to obtain a deformation of each fracture element, and bringing the deformation into equations (3) to (7) to obtain a stress distribution on a solution domain; and
S12: determining whether the fracture extends at a tip position by a stress intensity factor K;
the stress intensity factor K is calculated by the displacement discontinuity method:
$${K}_{I} = \frac{0.806 E \sqrt{π}}{4 ( 1 - {v}^{2} ) \sqrt{2 α}} {D}_{s} \qquad ( 21 )$$
$${K}_{II} = \frac{0.806 E \sqrt{π}}{4 ( 1 - {v}^{2} ) \sqrt{2 α}} {D}_{n}$$
wherein, K_{I} and K_{II} denote stress intensity factors of type I and type II, respectively; E denotes a Young's modulus; and α denotes a half-length of a tip element;
defining a criterion F to determine a direction of fracture initiation and extension:
$$F = {( \frac{{K}_{I} ( θ )}{{K}_{IC}} )}^{2} + {( \frac{{K}_{II} ( θ )}{{K}_{IIC}} )}^{2} \qquad ( 22 )$$
$${K}_{I} ( θ ) = \frac{1}{2} cos ( \frac{θ}{2} ) [ {K}_{I} ( 1 + cos θ ) - 3 {K}_{II} sin θ ] \qquad ( 23 )$$
$${K}_{II} ( θ ) = \frac{1}{2} cos ( \frac{θ}{2} ) [ {K}_{I} sin θ + {K}_{II} ( 3 cos θ - 1 ) ] \qquad ( 24 )$$
wherein, θ denotes a tip deflection angle of the fracture; K_{I} and K_{II} denote the stress intensity factors of type I and type II, respectively; and K_{IC} and K_{IIC} denote cracking toughness of type I and type II, respectively; and
determining, by a maximum value of F, a direction of fracture extension; and determining that the fracture starts to extend when F>1.

3. The method for coupling hydraulic fracture network extension and production performance of the horizontal well in the unconventional oil and gas reservoir according to claim 1, wherein step S2 comprises:
S21: generating a random point, a random azimuth and a random length by a random number generation method to model the natural fracture distribution characteristic, wherein a random point N (Nₓ,N_{y}) conforms to a uniform distribution on an interval [0,1]:
Nₓ=rₗ×randₖ (25)
N_{y}=r_{w}×randₖ₊₁ (26)
wherein, rₗ denotes a reservoir length; r_{w} denotes a reservoir width; and rand denotes a random number, with a subscript denoting a random number of times to generate the random number;
a fracture azimuth and a fracture length are expressed as follows:
θₚ=π×randₖ₊₂ (27)
lₚ=Lₘₐₓ×randₖ₊₃ (28)
wherein, θₚ denotes the fracture azimuth; and lₚ denotes the random fracture length;
S22: constructing a hydraulic fracture network extension model of the horizontal well by considering hydraulic fracture flow, extension and deformation, and constructing a mass conservation equation of a pure fracturing fluid component f by considering leakage:
$$- ∇ \cdot [ {ρ}_{f} {v}_{fl} {x}_{f} ( 1 - {\sum }_{p} {c}_{p} ) {w}_{F} ] + {q}_{f , wf} - {q}_{leak} ( 1 - {\sum }_{p} {c}_{p} ) {\sum }_{f} {x}_{f} {ρ}_{f} {w}_{F} = \frac{\partial }{\partial t} [ {ρ}_{f} {x}_{f} ( 1 - {\sum }_{p} {c}_{p} ) {w}_{F} ] \qquad ( 29 )$$
wherein, ρ_{f} denotes a density of the fracturing fluid component f in the fracture; v_{fl} denotes a seepage velocity of the fracturing fluid component f in an element l; x_{f} denotes a half-length of the fracture; cₚ denotes a compressibility of a proppant component P; w_{F} denotes a fracture aperture; and q_{f,wf} denotes a seepage flow rate from a natural fracture to a hydraulic fracture;
qₗₑₐₖ denotes a one-dimensional leakage rate, and is expressed as:
$${q}_{leak} = \frac{{C}_{leak}}{\sqrt{t - τ}} \qquad ( 30 )$$
wherein, Cₗₑₐₖ denotes a leakage coefficient; t denotes a production time; and τ denotes a shear stress at the fracture boundary;
deriving a mass conservation equation of the proppant component P:
$$- ∇ \cdot [ {ρ}_{p} {v}_{p} {c}_{p} {w}_{F} ] + {q}_{p , wf} = \frac{\partial }{\partial t} [ {ρ}_{p} {c}_{p} {w}_{F} ] \qquad ( 31 )$$
wherein, ρₚ denotes a density of the proppant component P in the fracture; vₚ denotes a migration velocity of the proppant component P; and q_{p,wf} denotes a flowback amount of the proppant component P under a bottomhole pressure;
based on a principle of mass conservation, a sand-carrying liquid in the fracture satisfies:
$$- ∇ \cdot [ {ρ}_{sl} {v}_{sl} {w}_{F} ] + {q}_{sl , wf} - {q}_{leak} ( 1 - {\sum }_{p} {c}_{p} ) {\sum }_{f} {x}_{f} {ρ}_{f} {w}_{F} = \frac{\partial }{\partial t} [ {ρ}_{{sl}^{{W}_{F}}} ] \qquad ( 32 )$$
wherein, ρₛₗ denotes a density of the sand-carrying liquid; and q_{sl,wf} denotes a flowback amount of the sand-carrying liquid under the bottomhole pressure;
a flow velocity of the sand-carrying liquid is expressed as:
$${v}_{sl} = - \frac{{w}_{F}^{2}}{12 {μ}_{sl}} ∇ ( P ) \qquad ( 33 )$$
wherein, μₛₗ denotes a viscosity of the sand-carrying liquid;
a total flow rate Q_{T} of an injected fluid satisfies a flow conservation relation:
$${Q}_{T} = {\sum }_{i}^{2} {\sum }_{j = 1}^{{N}_{F}} {Q}_{ji} \qquad ( 34 )$$
wherein, N_{F} denotes a total number of hydraulic fractures; and Qⱼᵢ denotes a flow rate of an i-th section of a j-th fracture, i=1 denoting an upper wing of the hydraulic fracture, and i=2 denoting a lower wing of the hydraulic fracture;
setting any fracture to have an internal pressure of P_{f,ji} and a bottom pressure of P_{w,ji}:
P_{w,ji}=P_{f,ji}+P_{vf,ji} (35)
wherein, P_{vf,ji} denotes a perforation friction pressure drop of the fracture, and is calculated as follows:
$${P}_{vf , ji} = \frac{{Q}_{ji}^{2} ρ}{{n}_{p}^{2} {d}^{4} {K}_{d}^{2}} \qquad ( 36 )$$
wherein, K_{d} denotes an empirical constant; d and nₚ denote a diameter of a perforation cluster and a number of perforation points, respectively; and ρ denotes a density of the fracturing fluid;
assuming that an injection pressure at a heel end of the horizontal well is P₀, then:
P₀=(P_{w,ji}+P_{cf,ji} (37)
wherein, P_{cf,ji} denotes a fluid flow friction pressure drop on the upper wing or the lower wing of the j-th fracture;
equations (34) to (37) constitute equations for solving fluid flow in a wellbore, and 2N_{F}+1 equations are constructed for 2N_{F}+1 unknowns (2N_{F} fracture flow rates Qⱼᵢ and bottomhole injection pressures P₀);
wellbore flow and hydraulic fracture flow are linked by an injection flow rate and a fracture pressure, and a fluid-solid coupled relationship between the fracture flow and the fracture extension deformation is constructed by the normal discontinuous displacement Dₙ of the fracture and the fracture aperture w_{F}:
Dₙ=−w_{F} (38)
constructing a fluid-solid coupled hydraulic fracture extension model:
$${N}_{f} \{ \begin{matrix}{\sum }_{j}^{{N}_{f}} {B}^{1 j} {D}_{{N}_{f}}^{j} - {σ}_{n , 1} = 0 \\ ⋮ \\ {\sum }_{j}^{{N}_{f}} {B}^{nj} {D}_{{N}_{f}}^{j} - {σ}_{n , {N}_{f}} = 0\end{matrix} \qquad ( 39 )$$
$${N}_{f} \{ \begin{matrix}- ∇ \cdot {[ {ρ}_{sl} {v}_{sl} w ]}_{1} + {( {q}_{sl , wf} )}_{1} - {[ {q}_{leak} ( 1 - {\sum }_{p} {c}_{p} ) {\sum }_{f} {x}_{f} {ρ}_{f} w ]}_{1} = \frac{\partial }{\partial t} {[ {ρ}_{sl} w ]}_{1} \\ ⋮ \\ - ∇ \cdot {[ {ρ}_{sl} {v}_{sl} w ]}_{{N}_{f}} + {( {q}_{sl , wf} )}_{{N}_{f}} - {[ {q}_{leak} ( 1 - {\sum }_{p} {c}_{p} ) {\sum }_{f} {x}_{f} {ρ}_{f} w ]}_{{N}_{f}} = \\ \frac{\partial }{\partial t} {[ {ρ}_{sl} w ]}_{{N}_{f}}\end{matrix}$$
$$1 : {Q}_{0} = {\sum }_{i = 1}^{2} {\sum }_{j}^{{N}_{pref}} {Q}_{ji}$$
$${N}_{pref} * 2 \{ \begin{matrix}{P}_{0} = {P}_{w , 1} + {P}_{c f , 1} \\ ⋮ \\ {P}_{0} = {P}_{w , {N}_{pref} * 2} + {P}_{cf , {N}_{pref} * 2}\end{matrix}$$
wherein, B^{nj} denotes a partial derivative of a shape function of the j-th fracture element; D_{N}_{_{f}}^{j} denotes an elastic coefficient of a material of the j-th fracture element; σ_{n,N}_{_{f}} denotes a stress acting on an N_{f}-th fracture element; w denotes a width of a fracture grid element; N_{pref} denotes a number of perforation holes; and N_{f} denotes a total number of fractures; and
solving main variables x^{T}=[D_{n,1}, D_{n,2}, . . . , D_{n,N}_{_{f}}, P₁, P₂, . . . P_{N}_{_{f}}, P₀, Q₁, Q₂, . . . , Q_{N}_{_{pref}}_{*2}] through an iterative algorithm, and updating the proppant component and the fracturing fluid component in a time step by equations (29) and (32).

4. The method for coupling hydraulic fracture network extension and production performance of the horizontal well in the unconventional oil and gas reservoir according to claim 1, wherein step S3 comprises:
S31: generating a geological body based on an actual geological condition of a research area, a trajectory of the horizontal well, and distribution characteristics of the hydraulic fracture and the natural fracture; and
S32: editing and importing data of the geological body, and generating a discrete model by three-dimensional orthogonal grids.

5. The method for coupling hydraulic fracture network extension and production performance of the horizontal well in the unconventional oil and gas reservoir according to claim 1, wherein step S4 comprises:
S41: constructing, based on the embedded discrete fracture model, the three-dimensional three-phase mathematical models of seepage for the fractured horizontal well, wherein for a matrix system:
$$\sum {q}_{omm} + \sum {q}_{onf} = \frac{{V}_{b}}{{α}_{c} Δ t} {Δ}_{t} [ \frac{( 1 - {s}_{g m} - {s}_{w m} ) {ϕ}_{m}}{{B}_{o m}} ] \qquad ( 40 )$$
$$\sum {q}_{w m m} + \sum {q}_{wmf} = \frac{{V}_{b}}{{α}_{c} Δ t} {Δ}_{t} ( \frac{{S}_{w m} {ϕ}_{m}}{{B}_{w m}} ) \qquad ( 41 )$$
$$\sum {q}_{gmm} + \sum {q}_{gmf} = \frac{{V}_{b}}{{α}_{c} Δ t} {Δ}_{t} [ \frac{{S}_{gm} {ϕ}_{m}}{{B}_{gm}} + \frac{( 1 - {s}_{gm} - {s}_{wm} ) {R}_{s} {ϕ}_{m}}{{B}_{o m}} ] \qquad ( 42 )$$
and for a fracture system:
$$\sum {q}_{of} + {q}_{ofm} + \sum {q}_{off} + {q}_{ofw} = \frac{{V}_{b}}{{α}_{c} Δ t} {Δ}_{t} [ \frac{( 1 - {s}_{g} - {s}_{wf} ) {ϕ}_{f}}{{B}_{of}} ] \qquad ( 43 )$$
$$\sum {q}_{wf} + {q}_{wfm} + \sum {q}_{wff} + {q}_{wfw} = \frac{{V}_{b}}{{α}_{c} Δ t} {Δ}_{t} ( \frac{{S}_{wf} {ϕ}_{f}}{{B}_{wf}} ) \qquad ( 44 )$$
$$\sum {q}_{gf} + {q}_{gfm} + \sum {q}_{gff} + {q}_{gfw} = \frac{{V}_{b}}{{α}_{c} Δ t} {Δ}_{t} [ \frac{{s}_{gf} {ϕ}_{f}}{{B}_{gf}} + \frac{( 1 - {s}_{gf} - {s}_{wf} ) {R}_{s} {ϕ}_{f}}{{B}_{of}} ] \qquad ( 45 )$$
wherein, subscripts o, g and w denote oil, gas and water phases, respectively; s(·) denotes a saturation, that is, a ratio of a fluid volume to a total pore volume, dimensionless, and involving the oil, gas and water phases, with subscripts m and f denoting the matrix system and the fracture system, respectively; B(·) denotes a fluid volume factor wherein the fluid volume factor is a ratio of a volume of the fluid of a same mass in the reservoir to a volume under a surface standard condition, dimensionless, and involving oil, gas and water phases in the matrix system and oil, gas and water phases in the fracture system, with subscripts m and f denoting the matrix system and the fracture system, respectively; V_{b} denotes a volume of a matrix grid block, m³; α_{c} denotes a volume conversion factor, and takes 1 in case of a metric unit; Δt denotes a time difference between two time points, d; ϕₘ and ϕ_{f} denote ratios of pore volumes in a matrix grid and a fracture grid to the volume of the matrix grid block (a matrix grid with a fracture embedded), respectively, dimensionless; Σq_{(·)mm} denotes a total flow rate from all matrix grids adjacent to the matrix grid into the matrix grid during a period of time Δt, m³/d, involving oil, gas and water phases; Σq_{(·)mf} denotes a total flow rate from all fracture grids embedded in the matrix grid into the matrix grid during the period of time Δt, m³/d, involving oil, gas and water phases; Σq_{(·)f} denotes a total flow rate from all adjacent fracture grids with a common edge in the fracture where the fracture grid is located into the fracture grid during the period of time Δt, m³/d, involving oil, gas and water phases; q_{(·)fm} denotes a flow rate from the matrix grid where the fracture grid is embedded into the fracture grid during the period of time Δt, m³/d, involving oil, gas and water phases; Σq_{(·)ff} denotes a total flow rate from all fracture grids, intersected by the fracture grid and located in the matrix grid where the fracture grid is embedded, into the fracture grid during the period of time Δt, involving oil, gas and water phases, m³/d; q_{(·)fw} denotes a flow rate from a well grid passing through the fracture grid into the fracture grid during the period of time Δt, involving oil, gas and water phases, and being a negative value when the horizontal well is a production well, m³/d; and Rₛ denotes a solution gas-oil ratio of crude oil, and reflects an amount of dissolved gas in formation oil under a reservoir temperature and pressure;
equations (40) to (45) define the three-dimensional three-phase mathematical models for the seepage of the fractured horizontal well; various fluid exchange terms in the equations can be written in a unified format of a product of a conductivity and a potential difference so as to expand the potential difference, and can also be expressed as a sum of fluid exchange induced by a pressure difference and a gravitational potential difference; and therefore, a fluid exchange expression of oil, gas and water is derived as follows:
$$q = T ( {Φ}_{2} - {Φ}_{1} ) = \{ \begin{matrix}{T}_{p} ( {p}_{o 2} - {p}_{o 1} ) + {T}_{Z} ( {Z}_{o 2} - {Z}_{o 1} ) \\ {T}_{p} ( {p}_{o 2} - {p}_{o 1} + {p}_{cow 1} - {p}_{cow 2} ) + {T}_{Z} ( {Z}_{w 2} - {Z}_{w 1} ) \\ {T}_{p} ( {p}_{o 2} - {p}_{o 1} + {p}_{cog 2} - {p}_{cog 1} ) + {T}_{Z} ( {Z}_{g 2} - {Z}_{g 1} )\end{matrix} \qquad ( 46 )$$
wherein, the conductivity T, Tₚ and Tz are expanded as follows:
T=G·fₚ(pₒ)·fₛ(s_{w},s_{g})=G·fₚ·fₛ (47)
wherein, G denotes a geometric parameter; fₚ denotes a pressure-related function; and fₛ denotes a saturation-related function;
the geometric parameter G is different in each connection pair, fₚ and fₛ differ slightly in different positions of the flow equation, and G, fₚ and fₛ are specifically defined as follows, wherein, L=w, o:
$$G ≡ {β}_{c} \frac{k A}{Δ l} \qquad ( 48 )$$
$${f}_{p} ≡ \frac{1}{{μ}_{L} {B}_{L}} or \frac{{γ}_{L}}{{μ}_{L} {B}_{L}} or \frac{{R}_{s}}{{μ}_{o} {B}_{o}} or \frac{{R}_{s} {γ}_{0}}{{μ}_{o} {B}_{o}} \qquad ( 49 )$$
$${f}_{s} ≡ {k}_{rL} \qquad ( 50 )$$
S42: constructing the fully implicit numerical model based on the finite difference method:
$$\begin{matrix}{q}^{n + 1} \approx {q}^{( v + 1 )} = {q}^{( v )} + \overline{δ} q \\ = {q}^{( v )} + \frac{\partial q}{\partial {p}_{oi}} {\overline{δ}}_{{P}_{oi}} + \frac{\partial q}{\partial {p}_{oj}} \overline{δ} {p}_{oj} + \frac{\partial q}{\partial {s}_{wi}} \overline{δ} {s}_{wi} + \\ \frac{\partial q}{\partial {s}_{wj}} \overline{δ} {s}_{wj} + \frac{\partial q}{\partial {s}_{gi}} \overline{δ} {s}_{gi} + \frac{\partial q}{\partial {s}_{gj}} \overline{δ} {s}_{gj}\end{matrix} \qquad ( 51 )$$
$$\begin{matrix}\frac{{V}_{b}}{{α}_{c} Δ t} {Δ}_{t} ( \frac{s ϕ}{B} ) = \frac{{V}_{b}}{{α}_{c} Δ t} [ {( \frac{s ϕ}{B} )}^{n + 1} - {( \frac{s ϕ}{B} )}^{n} ] \approx \frac{{V}_{b}}{{α}_{c} Δ t} [ {( \frac{s ϕ}{B} )}^{( v + 1 )} - {( \frac{s ϕ}{B} )}^{n} ] \\ = \frac{{V}_{b}}{{α}_{c} Δ t} [ {( \frac{s ϕ}{B} )}^{( v )} + \overline{δ} ( \frac{s ϕ}{B} ) - {( \frac{s ϕ}{B} )}^{n} ] \\ = \frac{{V}_{b}}{{α}_{c} Δ t} [ {( \frac{s ϕ}{B} )}^{( v )} - {( \frac{s ϕ}{B} )}^{n} + \frac{\partial ( \frac{s ϕ}{B} )}{\partial {p}_{oi}} {\overline{δ}}_{{P}_{oi}} + \\ \frac{\partial ( \frac{s ϕ}{B} )}{\partial {s}_{wi}} \overline{δ} {s}_{wi} + \frac{\partial ( \frac{s ϕ}{B} )}{\partial {s}_{gi}} \overline{δ} {s}_{gi} ]\end{matrix} \qquad ( 52 )$$
wherein, superscripts n and n+1 denote n-th and (n+1)-th time steps, and superscripts (v) and (v+1) denote v-th and (v+1)-th iteration steps; when a value of the (v+1)-th iteration step approaches a value of the (n+1)-th time step, a satisfied iteration accuracy is achieved; δ̅ denotes a parameter change value between two iteration steps; and a subscript i denotes a grid expressed by the seepage equation, and a subscript j denotes a grid in fluid exchange with the i-th grid.

6. The method for coupling hydraulic fracture network extension and production performance of the horizontal well in the unconventional oil and gas reservoir according to claim 5, wherein in step S5, the step of iteratively solving the constructed fully implicit numerical model, and predicting the post-fracture production performance characteristic of the horizontal well comprises:
assuming there are N fracture grids in M matrix grids, each grid being expressed by three equations of oil, gas and water and having three unknowns δ̅pₒᵢ, δ̅s_{wi} and δs_{gi}, then constructing a fully implicit calculation matrix considering reservoir seepage and hydraulic fracture flow:
E_{3(M+N)×3(M+N)}×δX_{3(M+N)×1}F_{3(M+N)×1} (53)
wherein, E_{3(M+N)×3(M+N)} denotes a coefficient matrix; δ̅X_{3(M+N)×1} denotes an unknown vector; and F_{3(M+N)×1} denotes a constant vector;
iteratively calculating for each time step until a satisfied accuracy of the unknown vector δ̅X_{3(M+N)×1} thereby obtaining a pressure value and a saturation value at the (n+1)-th time step; and starting a cycle at a next time step; and
finally, outputting pressure and saturation distributions of the reservoir at each time step, and calculating a production performance of the fractured horizontal well according to a production formula, wherein since each fractured horizontal well comprises multiple hydraulic fractures, an output of the fractured horizontal well is a sum of flow rates of all fractures flowing into a wellbore; and a flow rate of each fracture flowing into the wellbore is:
wherein,
$${q}_{L} = {WI}_{f} {f}_{s} {f}_{p} ( {P}_{wf} - {p}_{f} ) {WI}_{f} = \frac{Δθ \cdot {k}_{f} {ω}_{f}}{ln ( \frac{0.14 \sqrt{{L}_{f}^{2} + {h}_{f}^{2}}}{{r}_{w}} )} \qquad ( 54 )$$
wherein, p_{wf} denotes a flowing bottomhole pressure; p_{f} denotes a pressure of the fracture grid; k_{f} denotes a fracture permeability, D; ω_{f} denotes a fracture aperture, m; L^{f} and h_{f} respectively denote a length and a height of a fracture section, m; and Δθ denotes a central angle of a radial well in the fracture, rad.
